(19) United States
(12) Patent Application Publication
(10) Pub. No.: US 2008/0166591 A1
(43) Pub. Date: Jul. 10, 2008

(54) CARBAZOLE COMPOUND AND ORGANIC LIGHT-EMITTING DEVICE USING SAME

(75) Inventors: Naoki Yamada, Inagi-shi (JP); Jun Kamatani, Tokyo (JP); Ryota Ooishi, Yokohama-shi (JP); Hiroki Ohrui, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/964,132

(22) Filed: Dec. 26, 2007

(30) Foreign Application Priority Data
Dec. 27, 2006 (JP) 2006-351757

(51) Int. Cl. B32B 9/04; C09K 11/00

(52) U.S. Cl. 428/690

(57) ABSTRACT

There are provided a novel carbazole compound and an organic light-emitting device having an optical output with extremely high efficiency and luminance and having extremely high durability. Specifically, there are provided a novel carbazole compound represented by the general formula (1):

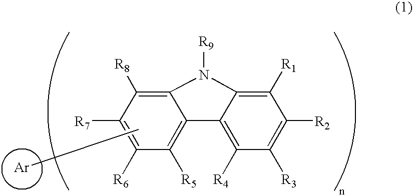

wherein Ar represents a substituted or unsubstituted bipyridine group, a substituted or unsubstituted terpyridine group, or a substituted or unsubstituted 4,5-diazafluorene group and is bonded to any of the eight available carbon atoms on the carbazole skeleton, and an organic light-emitting device using the carbazole compound.

### BACKGROUND OF THE INVENTION

1. Field of the Invention

The present invention relates to a novel carbazole compound and an organic light-emitting device using the carbazole compound.

2. Description of the Related Art

An organic light-emitting device is a device in which a thin film containing a fluorescent organic compound or a phosphorescent organic compound is interposed between an anode and a cathode and in which holes (positive holes) and electrons are injected from the electrodes to generate excitons of the fluorescent compound or phosphorescent compound, and when the excitons return to a ground state, light is emitted.

Recent progress of an organic light-emitting device is remarkable, and is characterized in that a highly responsive, thin, and lightweight light-emitting device that can be driven at a low applied voltage and provides a high luminance and a variety of emission wavelengths can be made, which suggests the applicability to a wide variety of uses.

However, at present, an optical output of a higher luminance and a higher conversion efficiency are required. In addition, there still remain a large number of problems in terms of durability such as a change over time during long-term use and degradation due to an atmospheric gas containing oxygen or to moisture.

Furthermore, light emission of blue, green and red colors having a high color purity is necessary when application to a full-color display or the like is attempted. However, those problems have not been sufficiently solved yet.

Here, as a material for an organic light-emitting device which improves the color purity of light emission of an organic light-emitting device, carbazole compounds have been proposed. Japanese Patent Application Laid-Open Nos. 2004-079265 and 2003-226870 disclose examples of a material using a carbazole compound and an organic light-emitting device using the material. However, the emission efficiency of the device is low and the durability life of the device is not sufficient.

### SUMMARY OF THE INVENTION

The present invention provides a novel carbazole compound. Further, the present invention provides an organic light-emitting device having an optical output with extremely high efficiency and also having luminance and extremely high durability. Moreover, the present invention provides an organic light-emitting device that can easily be produced at a relatively low cost.

According to the present invention, there is provided a carbazole compound represented by the following general formula (I):

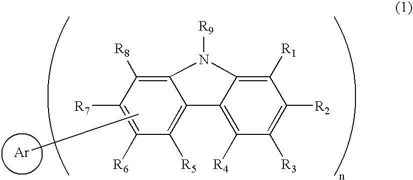

wherein Ar represents a substituted or unsubstituted bipyridine group, a substituted or unsubstituted terpyridine group, or a substituted or unsubstituted 4,5-diazafluorene group and is bonded to any of the eight available carbon atoms on the carbazole skeleton;

R₁, R₂, R₃, R₄, R₅, R₆, R₇, and R₈, when bonded to the available carbon atoms other than the Ar-bonded carbon atom(s) on the carbazole skeleton, and R₉ each represent, independently of one another, a hydrogen atom, a substituted or unsubstituted alkyl group, an aralkyl group, an alkoxy group, a substituted or unsubstituted aryl group, a substituted or unsubstituted heterocyclic group, a substituted amino group, a cyano group, or a halogen group, or adjacent ones of R₁, R₂, R₃, R₄, R₅, R₆, R₇, R₈, and R₉ may be joined to form a ring; and

n represents an integer of 1 to 4.

According to the present invention, a novel carbazole compound having good film property and excellent emission characteristics can be provided. Further, according to the present invention, an organic light-emitting device which can be driven at a low applied voltage and has a high emission efficiency can be provided.

Further features of the present invention will become apparent from the following description of exemplary embodiments with reference to the attached drawings.

### BRIEF DESCRIPTION OF THE DRAWINGS

FIG. 1 is a schematic cross-sectional view illustrating a first embodiment of the organic light-emitting device in accordance with the present invention.

FIG. 2 is a schematic cross-sectional view illustrating a second embodiment of the organic light-emitting device in accordance with the present invention.

FIG. 3 is a schematic cross-sectional view illustrating a third embodiment of the organic light-emitting device in accordance with the present invention.

FIG. 4 is a schematic cross-sectional view illustrating a fourth embodiment of the organic light-emitting device in accordance with the present invention.

FIG. 5 is a schematic cross-sectional view illustrating a fifth embodiment of the organic light-emitting device in accordance with the present invention.

### DESCRIPTION OF THE EMBODIMENTS

The present invention will be described in detail below.

First, the carbazole compound of the present invention will be described.

The carbazole compound is represented by the following general formula (I):

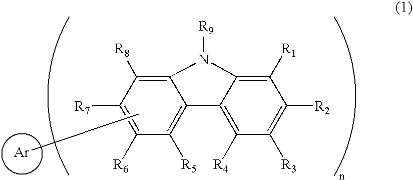

In the general formula (I), Ar represents a substituted or unsubstituted bipyridine group, a substituted or unsubstituted terpyridine group, a substituted or unsubstituted 4,5-diazafluorene group with a substituted or unsubstituted 4,5-diazafluorene group being preferred.

Examples of a bipyridine group representing Ar include, but are not limited to, 2,2′-bipyridine-6,6′-diyl group, 2,2′-bipyridine-5,5′-diyl group, 2,2′-bipyridine-4,4′-diyl group, 2,2′-bipyridine-3,3′-diyl group, 4,4′-bipyridine-2,2′-diyl group, 3,3′-bipyridine-2,2′-diyl group, 2,2′-bipyridine-6,4,6′-triyl group, 2,2′-bipyridine-5,6,6′-triyl group, 2,2′-bipyridine-4,6,4′,6′-tetrayl group, 2,2′-bipyridine-4,5,5′,6′-tetrayl group, and 4,4′-bipyridine-2,6,2′,6′-tetrayl group, with 2,2′-bipyridine-6,6′-diyl group being preferred.

Examples of a terpyridine group representing Ar include, but are not limited to, 2,2′,6′,2″-terpyridine-6,6″-diyl group, 2,2′,6′,2″-terpyridine-5,5″-diyl group, 2,2′,6′,2″-terpyridine-4,4″-diyl group, and 2,2′,6′,2″-terpyridine-6,4′,6″-triyl group.

Examples of a 4,5-diazafluorene group representing Ar include, but are not limited to, 4,5-diazafluorene-2,7-diyl group and 4,5-diazafluorene-3,6-diyl group, with 4,5-diazafluorene-3,6-diyl group being preferred.

Examples of the substituents which the above described bipyridine group, terpyridine group, or 4,5-diazafluorene group may further posses include, but are not limited to, an alkyl group such as methyl group, ethyl group, or propyl group; an aralkyl group such as benzyl group or phenethyl group; an aryl group such as phenyl group or biphenyl group; a heterocyclic group such as thienyl group, pyrrolyl group, or pyridyl group; a substituted amino group such as dimethylamino group, diethylamino group, dibenzylamino group, diphenylamino group, ditolylamino group, or dianisolylamino group; an alkoxy group such as methoxy group, ethoxy group, propoxy group, or phenoxy group; a cyano group; and a halogen atom such as fluorine or chlorine.

In the general formula (I), Ar is bonded to any of the eight available carbon atoms on the carbazole skeleton, that is, Ar is bonded to the carbazole ring structure at any of the positions at which R₁, R₂, R₃, R₄, R₅, R₆, R₇, and R₈ are bonded to the carbazole ring.

On the other hand, R₁, R₂, R₃, R₄, R₅, R₆, R₇, and R₈, when bonded to the available carbon atoms other than the Ar-bonded carbon atom(s) on the carbazole skeleton (that is, when bonded to the carbazole ring at position(s) at which Ar is not bonded to the carbazole ring), as well as R₉ each represent, independently of one another, a hydrogen atom, a substituted or unsubstituted alkyl group, an aralkyl group, an alkoxy group, a substituted or unsubstituted aryl group, a substituted or unsubstituted heterocyclic group, a substituted amino group, a cyano group, or a halogen atom.

Examples of the alkyl group representing R₁, R₂, R₃, R₄, R₅, R₆, R₇, and R₈ include, but are not limited to, methyl group, ethyl group, n-propyl group, iso-propyl group, n-butyl group, tert-butyl group, sec-butyl group, octyl group, 1-adamantyl group, and 2-adamantyl group.

Examples of the aralkyl group representing R₁, R₂, R₃, R₄, R₅, R₆, R₇, and R₈ include, but are not limited to, benzyl group and phenethyl group.

Examples of the alkoxy group representing R₁, R₂, R₃, R₄, R₅, R₆, R₇, and R₈ include, but are not limited to, methoxy group, ethoxy group, propoxy group, and phenoxy group.

Examples of the aryl group representing R₁, R₂, R₃, R₄, R₅, R₆, R₇, and R₈ include, but are not limited to, phenyl group, naphthyl group, pentalenyl group, indenyl group, azulenyl group, anthryl group, pyrenyl group, indacenyl group, acenaphthenyl group, phenanthryl group, phenalenyl group, fluoranthenyl group, acephenanthryl group, aceanthryl group, triphenylenyl group, chrysenyl group, naphthacenyl group, perylenyl group, pentacenyl group, biphenyl group, terphenyl group, and fluorenyl group.

Examples of the heterocyclic group representing R₁, R₂, R₃, R₄, R₅, R₆, R₇, and R₈ include, but are not limited to, thienyl group, pyrrolyl group, pyridyl group, oxazolyl group, oxadiazolyl group, thiazolyl group, thiadiazolyl group, terthienyl group, carbazolyl group, acridinyl group, and phenanthrolyl group.

Examples of the heterocyclic group representing R₁, R₂, R₃, R₄, R₅, R₆, R₇, and R₈ include fluorine, chlorine, bromine, and iodine.

Examples of the substituted amino group representing R₁, R₂, R₃, R₄, R₅, R₆, R₇, and R₈ include, but are not limited to, dimethylamino group, diethylamino group, dibenzylamino group, diphenylamino group, ditolylamino group, and dianisolylamino group.

Examples of the substituents which the above described alkyl group, aryl group or heterocyclic group may further posses include, but are not limited to, an alkyl group such as methyl group, ethyl group, or propyl group; an aralkyl group such as benzyl group or phenethyl group; an aryl group such as phenyl group or biphenyl group; a heterocyclic group such as thienyl group, pyrrolyl group, or pyridyl group; a substituted amino group such as dimethylamino group, diethylamino group, dibenzylamino group, diphenylamino group, ditolylamino group, or dianisolylamino group; an alkoxy group such as methoxy group, ethoxy group, propoxy group, or phenoxy group; a cyano group; and a halogen atom such as fluorine or chlorine.

The substituents R₁, R₂, R₃, R₄, R₅, R₆, R₇, R₈, and R₉ may be the same or different from one another. Alternatively, adjacent ones of the substituents R₁, R₂, R₃, R₄, R₅, R₆, R₇, R₈, and R₉ may be joined to form a ring.

Further, n represents an integer of 1 to 4.

The carbazole compound of the present invention can be used as a material for an organic light-emitting device.

The carbazole compound of the present invention has a substituent with a pyridine skeleton such as a bipyridine group incorporated into a carbazole group. Therefore, the carbazole compound of the present invention has both a hole injection property derived from the carbazole group and an electron injection property derived from the pyridine skeleton. Accordingly, the carbazole compound has good injection properties for the both kinds of carriers, and when the carbazole compound is used as a material for an organic light-emitting device, the driving voltage can be reduced.

Further, in the carbazole compound of the present invention, by incorporating the substituent into the carbazole group or pyridine skeleton, the HOMO/LUMO levels can easily be adjusted. Therefore, molecular design can be achieved while taking account of the balance of injection of carriers such as holes and electrons, and also molecular design for materials that emit blue, green or red light can be performed.

Further, the carbazole compound of the present invention has high amorphous property and high thermal stability, and therefore, when incorporated into an organic light-emitting device, prolongs the life of the device. In particular, a compound in which the carbazole group is substituted with 4,5-diazafluorene group(s) has amorphous property which is significantly higher than that of a compound with a pyridine skeleton such as a bipyridine group and further has higher thermal stability.

Specific examples of the carbazole compound of the present invention are shown below. However, these examples are merely representative examples, and the present invention is not limited thereto.

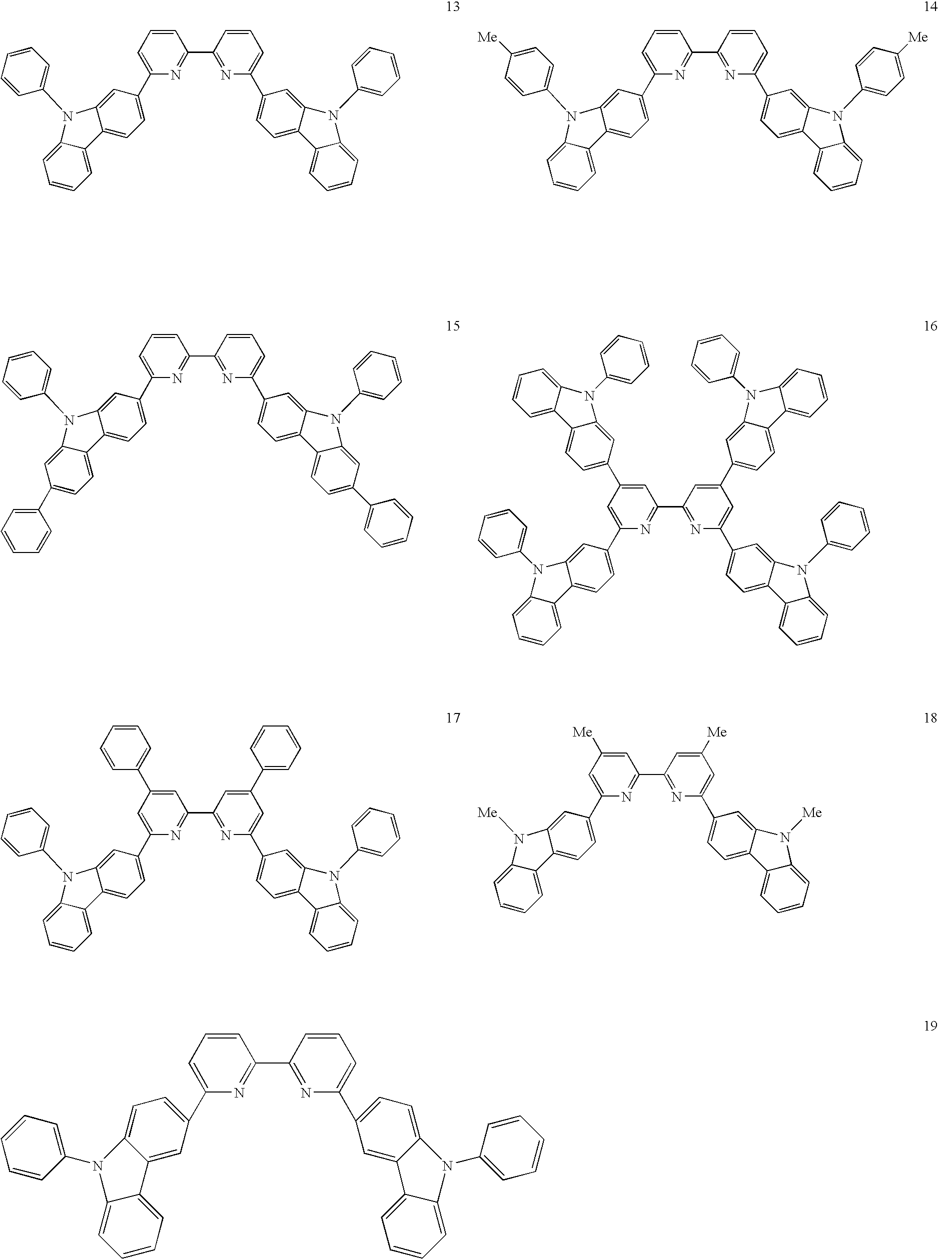

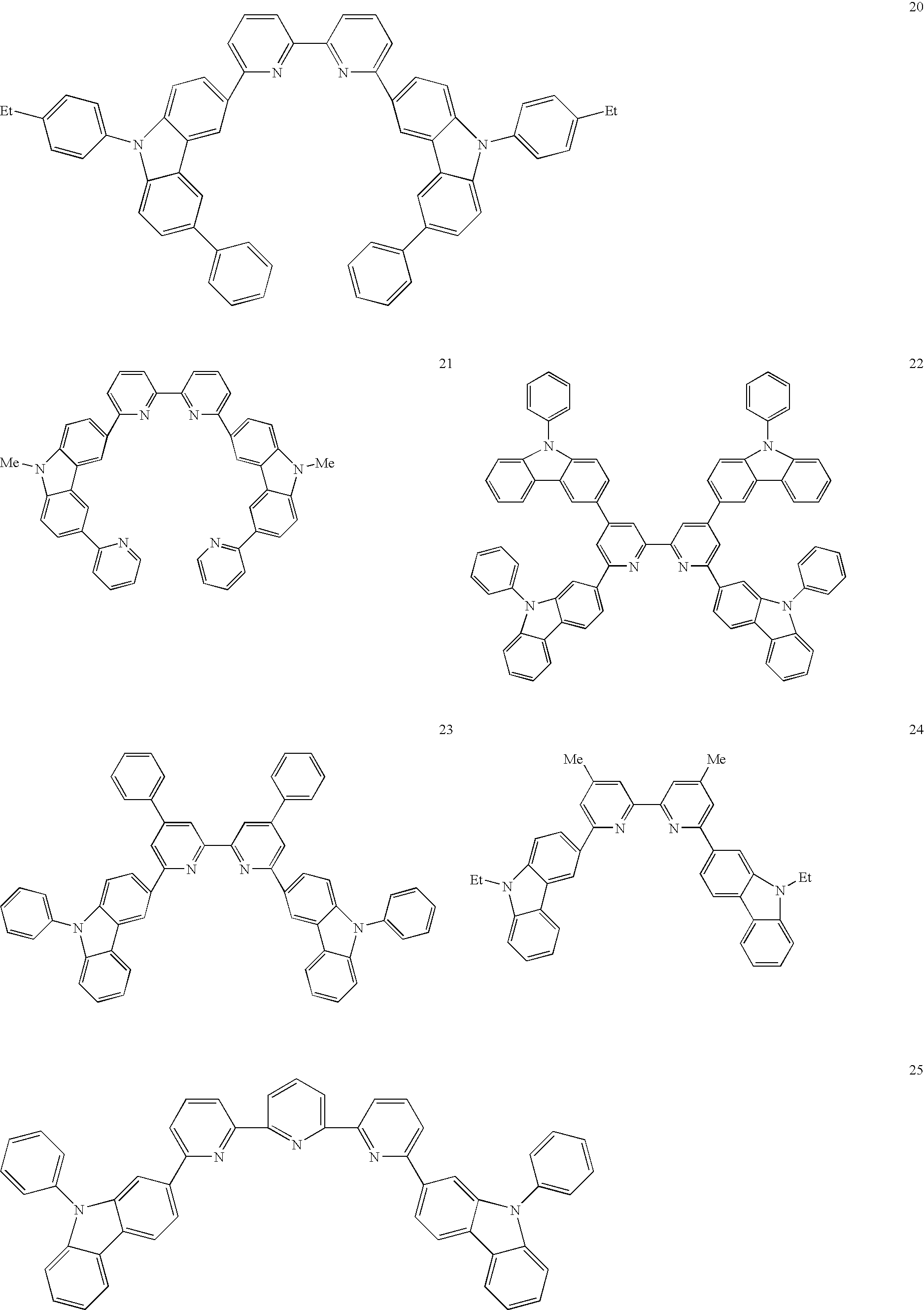

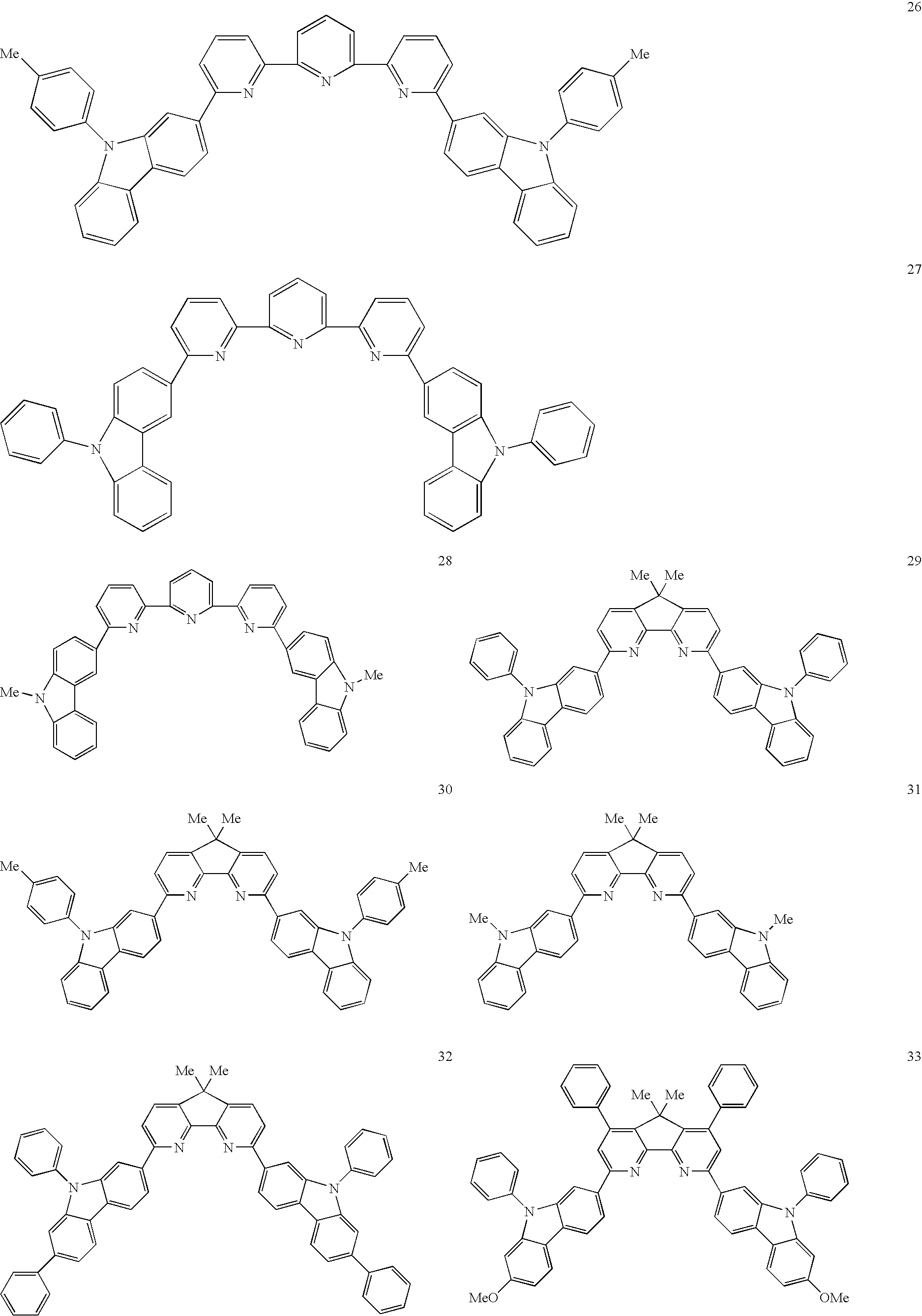

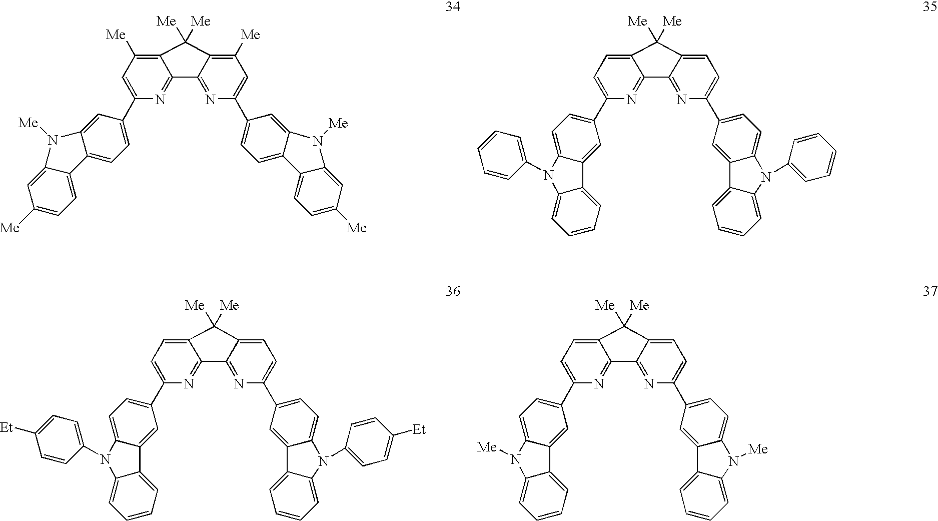

Next, the organic light-emitting device of the present invention will be described in detail.

The organic light-emitting device of the present invention has a pair of electrodes including an anode and a cathode, and at least one layer containing an organic compound and interposed between the pair of electrodes. Further, the layer containing the organic compound of the organic light-emitting device of the present invention contains at lest one of the carbazole compounds of the present invention.

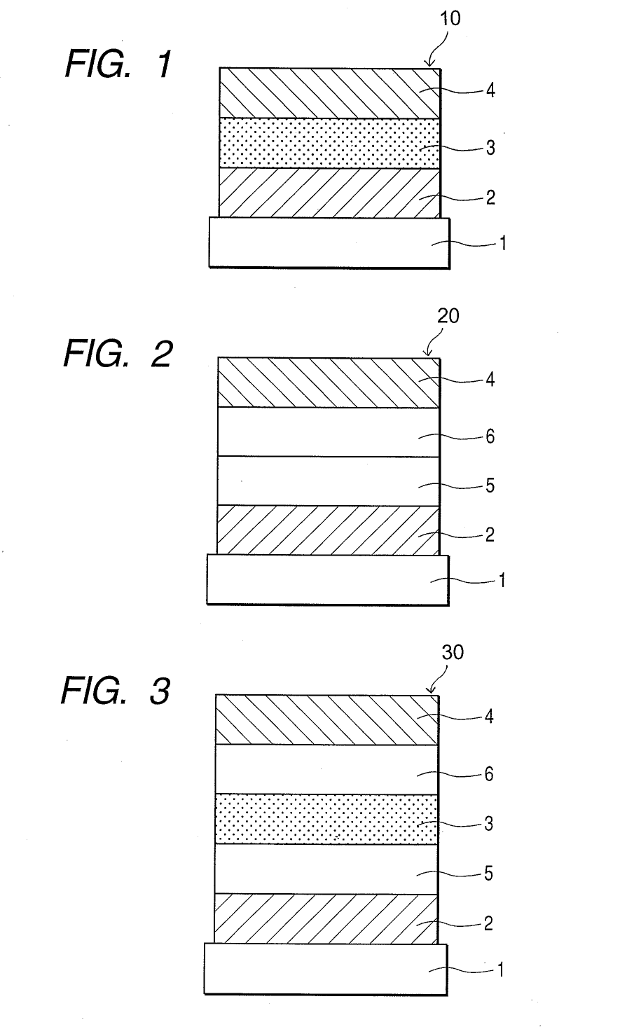

The organic light-emitting device of the present invention will be described in detail with reference to the attached drawings. Basic configurations of the organic light-emitting device of the present invention are illustrated in FIGS. 1, 2, 3, 4, and 5. In the figures, reference numeral 1 denotes a substrate, 2 an anode, 3 a light-emitting layer, 4 a cathode, 5 a hole-transporting layer, 6 an electron-transporting layer, 7 a hole injection layer, 8 a hole/exciton blocking layer, and 10, 20, 30, 40, and 50 each denote an organic light-emitting device.

FIG. 1 is a schematic cross-sectional view illustrating a first embodiment of the organic light-emitting device of the present invention. In the organic light-emitting device 10 shown in FIG. 1, there are sequentially provided on a substrate 1, an anode 2, a light-emitting layer 3 and a cathode 4. The configuration of the organic light-emitting device 10 is useful when the light-emitting layer 3 is composed of a compound having all of hole transporting ability, electron transporting ability and light emitting ability, or when the light-emitting layer 3 is composed of a mixture of compounds having hole transporting ability, electron transporting ability and light emitting ability, respectively.

FIG. 2 is a schematic cross-sectional view illustrating a second embodiment of the organic light-emitting device of the present invention. In the organic light-emitting device 20 shown in FIG. 2, there are sequentially provided on a substrate 1, an anode 2, a hole-transporting layer 5, an electron-transporting layer 6, and a cathode 4. The configuration of the organic light-emitting device 20 is useful when a light-emitting compound also having at least one of hole transporting ability and electron transporting ability and an organic compound having only hole transporting ability or electron transporting ability are used in combination. Incidentally, in the organic light-emitting device 20 shown in FIG. 2, the hole-transporting layer 5 and the electron-transporting layer 6 each serve also as a light-emitting layer.

FIG. 3 is a schematic cross-sectional view illustrating a third embodiment of the organic light-emitting device of the present invention. The organic light-emitting device 30 shown in FIG. 3 is different from the organic light-emitting device 20 shown in FIG. 2 in that a light-emitting layer 3 is additionally provided between a hole-transporting layer 5 and an electron-transporting layer 6. The organic light-emitting device 30 has a configuration in which the functions of carrier transportation and light emission are separated from each other, so that organic compounds having characteristics of hole-transporting property, electron-transporting property and light-emitting property, respectively, can suitably be combined and used. Therefore, since the degree of freedom in selecting materials can significantly be increased, and further since various organic compounds having different emission wavelengths can be used, a wide variety of emission hues can be provided. Further, it also becomes possible to effectively confine carriers or excitons in the light-emitting layer 3, thereby improving the emission efficiency.

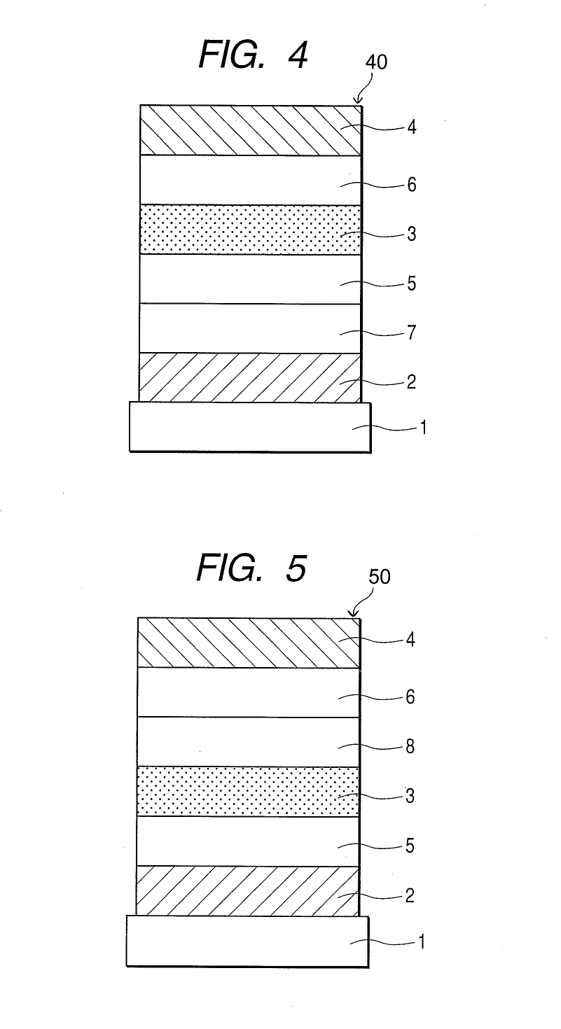

FIG. 4 is a schematic cross-sectional view illustrating a fourth embodiment of the organic light-emitting device of the present invention. The organic light-emitting device 40 shown in FIG. 4 is different from the organic light-emitting device 30 shown in FIG. 3 in that a hole injection layer 7 is additionally provided between an anode 2 and a hole-transporting layer 5. In the organic light-emitting device 40, by additionally providing the hole injection layer 7, the adhesion between the anode 2 and the hole-transporting layer 5 is improved and the hole injection property is also improved, so that the driving voltage can be effectively reduced.

FIG. 5 is a schematic cross-sectional view illustrating a fifth embodiment of the organic light-emitting device of the present invention. The organic light-emitting device 50 shown in FIG. 5 is different from the organic light-emitting device 30 shown in FIG. 3 in that a layer (hole/exciton blocking layer 8) for blocking holes or excitons from passing to a cathode 4 side is additionally provided between a light-emitting layer 3 and an electron-transporting layer 6. The configuration improves the emission efficiency of the organic light-emitting device 50 by using an organic compound with a significantly high ionization potential as the hole/exciton blocking layer 8.

FIGS. 1 to 5 merely show very basic device configurations and the configuration of the organic light-emitting device using the carbazole compound according to the present invention is not limited thereto. For example, it is possible to adopt various layer structures, such as one in which an insulating layer is formed at an interface between an electrode and an organic layer, one in which an adhesive layer or an interference layer is formed, and one in which a hole-transporting layer is composed of two layers having different ionization potentials.

The carbazole compound of the present invention can be used as a material for constituting a layer containing an organic compound, for example, a light-emitting layer 3, a hole-transporting layer 5, an electron-transporting layer 6, a hole injection layer 7, and a hole/exciton blocking layer 8. In an organic light-emitting device produced by using the carbazole compound of the present invention as a material for constituting the above-mentioned layer(s), improvement of the emission efficiency and prolongation of the life can be achieved.

The carbazole compound of the present invention is preferably used as a material for constituting a light-emitting layer 3. When the carbazole compound of the present invention is used as a material for constituting a light-emitting layer 3, the compound can be utilized in various forms. As the forms of utilization, for example, the compound can be used singly, can be used as a dopant (guest) material in combination with a host material, or can be used as a host material in combination with a guest material such as a fluorescent material of a phosphorescent material. Further, by incorporating the carbazole compound of the present invention into a light-emitting layer 3, the color purity and emission efficiency are improved and the life is increased as compared when incorporated into another layer.

In the organic light-emitting device of the present invention, as a material for constituting a light-emitting layer, the carbazole compound of the present invention can be used not only singly but also in combination with a hitherto known low-molecular or polymer hole-transporting compound, light-emitting compound, or electron-transporting compound as needed.

The substrate used in the organic light-emitting device of the present invention may be, although not particularly limited, a non-transparent substrate such as a metal substrate or a ceramic substrate, or a transparent substrate formed of glass, quartz, plastic sheet, or the like.

Further, it is also possible to control the emission color by using a color filter film, a fluorescent color conversion filter film, a dielectric reflection film or the like for the substrate. Moreover, it is also possible to form a thin film transistor (TFT) on a substrate and then form a device in connection thereto.

Moreover, for the direction in which light is extracted from a device, both a bottom emission structure (light is extracted from a substrate side) and a top emission structure (light is extracted from a side opposite to a substrate side) can be adopted.

An organic compound layer composed of the carbazole compound of the present invention is preferably formed by a vacuum evaporation method or a solution coating method because a film formed by such methods is less susceptible to crystallization and excellent in stability over time.

### EXAMPLES

Hereinafter, the present invention will be described specifically by way of examples. However, the present invention is not limited to those examples.

### Example 1

### Synthesis of Exemplified Compound 30

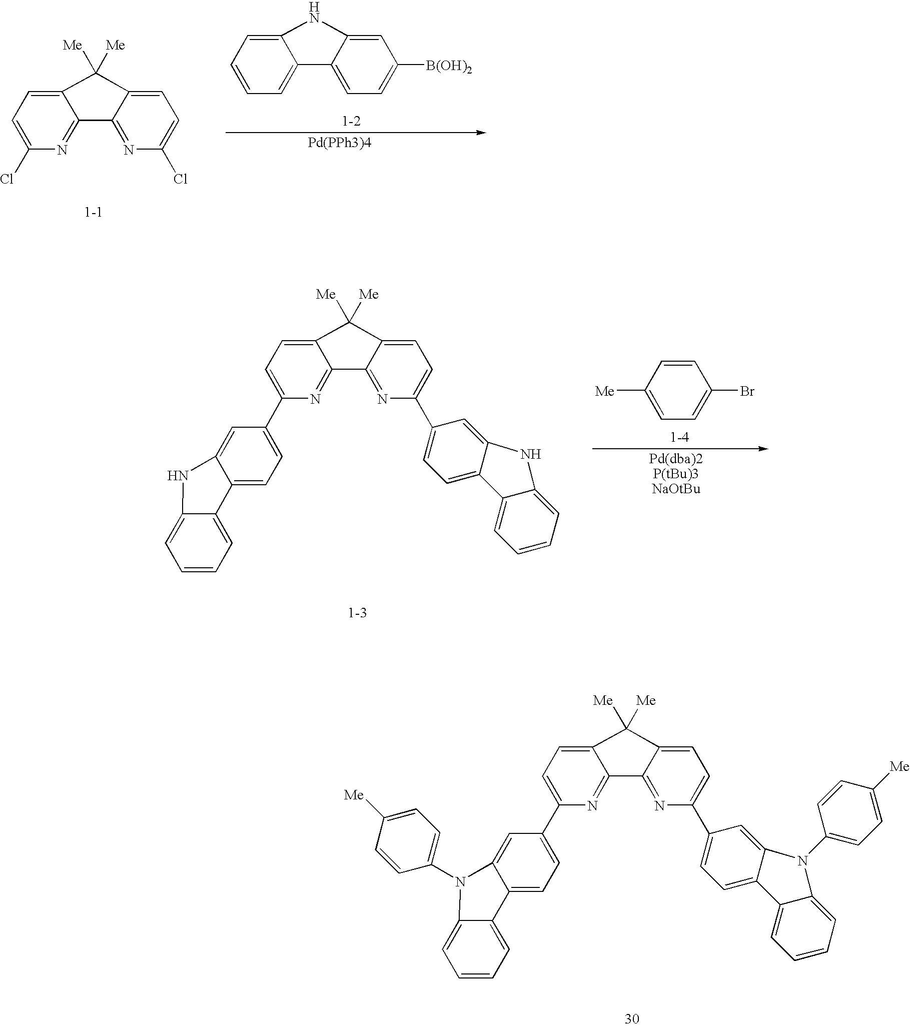

(1) Synthesis of Intermediate Compound 1-3

The following reagents and solvents were placed in a 200 mL three-necked flask.

Compound 1-1: 0.87 g (3.35 mmol)
Compound 1-2: 2.93 g (10.00 mmol)

### Toluene: 120 mL

### Ethanol: 20 mL

Next, while the resulting solution was stirred under nitrogen flow at room temperature, an aqueous solution of 10 g of sodium carbonate in 100 mL of water was added dropwise thereto and then 0.387 g (0.335 mmol) of tetraxis(triphenylphosphine)palladium(0) was further added. Then, the solution was heated to 77° C. and stirred for 5 hours. After the reaction, the organic layer was extracted with toluene and dried with anhydrous sodium sulfate, and then purified by silica gel chromatography (developing solvent: chloroform) to give 1.57 g of a yellowish white crystal of Intermediate Compound 1-3 (yield: 85%).

By means of a mass spectrometry, 522 as M+ of the compound was confirmed.

(2) Synthesis of Exemplified Compound 30

The following reagents and solvents were placed in a 200 mL three-necked flask.

Compound 1-3: 1.04 g (2.00 mmol)
Compound 1-4: 3.42 g (20.00 mmol)
Sodium tert-butoxide: 0.768 g (8.00 mmol)

### Xylene: 100 mL

Next, while the resulting solution was stirred under nitrogen flow at room temperature, 80.7 mg (0.40 mmol) of tri-tert-butylphosphine was added thereto and then 115 mg (0.20 mmol) of palladium dibenzylideneacetone was further added. Then, the solution was heated to 125° C. and stirred for 5 hours. After the completion of the reaction, the organic layer was extracted with toluene and dried with anhydrous sodium sulfate, and then purified by silica gel chromatography (developing solvent: chloroform) to give 1.23 g of a white crystal of Exemplified Compound 30 (yield: 87%).

By means of a mass spectrometry, 707.9 as M+ of the compound was confirmed. Further, by means of a differential scanning calorimetry (DSC), a glass transition temperature of 172° C. was confirmed.

In addition, when emission spectrum of the compound in dilute toluene solution was measure by using a fluorescence spectrophotometer F-4500 (trade name; manufactured by Hitachi, Ltd.), a distinct blue color was obtained.

### Example 2

An organic light-emitting device having a configuration shown in FIG. 4 was prepared with a method described below.

A transparent conductive support substrate was prepared which had a film of indium tin oxide (ITO) with a thickness of 120 nm as an anode 2 formed on a glass substrate 1 by a sputtering method. The transparent conductive support substrate was ultrasonically cleaned sequentially with acetone and isopropyl alcohol (IPA), subsequently cleaned with pure water, was dried in a vacuum oven at 120° C., was further cleaned with UV/ozone, and was used.

Next, a chloroform solution of a compound represented by the following structural formula 2-1, which was a hole injection material, was prepared so that the concentration became 0.1 wt. %.

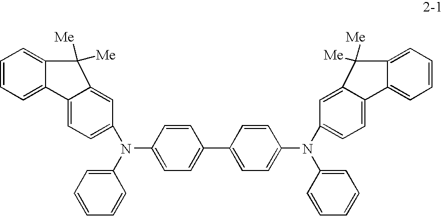

The solution was dropped on the above described transparent conductive support substrate and spin-coated at first for 10 seconds at a rotation speed of 500 RPM and then for 40 seconds at a rotation speed of 1,000 RPM, to form a film. The substrate was dried in a vacuum oven at 80° C. for 10 minutes to completely remove the solvent in the thin film. Thus, a hole injection layer 7 was formed. The thus formed hole injection layer 7 had a film thickness of 15 nm.

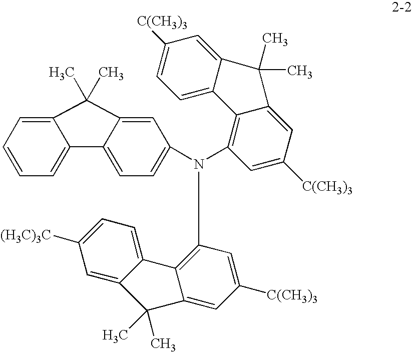

Then, a compound represented by the following structural formula 2-2 was evaporated on the hole injection layer 7 to form a hole-transporting layer 5 having a film thickness of 20 nm.

Subsequently, a light-emitting layer 3 with a thickness of 25 nm was provided on the hole-transporting layer 5 by co-depositing Ir(ppy)₃ as a first compound and Exemplified Compound 30 as a second compound (weight ratio of (Ir(ppy)₃):(Exemplified Compound 30) being 5:95). The film deposition was performed under the conditions of a vacuum degree during evaporation of 1.0×10⁻⁴ Pa and a film deposition rate of 0.1 nm/sec or more and 0.2 nm/sec or less.

Thereafter, as an electron-transporting layer 6,1,10-diphenylphenanthroline was deposited thereon in a film thickness of 50 nm through a vacuum evaporation method. The film deposition was performed under the conditions of a vacuum degree during evaporation of 1.0×10⁻⁴ Pa and a film deposition rate of 0.1 nm/sec or more and 0.2 nm/sec or less.

Then, a film of potassium fluoride (KF) was formed in a thickness of 0.5 nm thereon by a vacuum evaporation method. As for the evaporation conditions at that time, the vacuum degree was 1.0×10⁻⁴ Pa and the film deposition rate was 0.01 nm/sec. Finally, an aluminum film was formed in a thickness of 150 nm thereon by a vacuum evaporation method. As for the evaporation conditions at that time, the vacuum degree was 1.0×10⁻⁴ Pa and the film deposition rate was 1.0 nm/sec or more and 1.2 nm/sec or less. The potassium fluoride film and the aluminum film function as an electron injection electrode (cathode 4).

The resulting device was covered with a protective glass plate in a dry air atmosphere so that the device was not degraded through adsorbing moisture, and was encapsulated with an acrylic resin adhesive. Thus, an organic light-emitting device was completed.

When a voltage of 4 V was applied to the thus obtained device with the ITO electrode (anode 2) being used as a positive electrode and the aluminum electrode (cathode 4) being used as a negative electrode, emission of a green light was observed at an emission luminance of 2,400 cd/m².

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-351757, filed on Dec. 27, 2007, which is hereby incorporated by reference herein in its entirety.

What is claimed is:

1. A carbazole compound represented by the general formula (1): 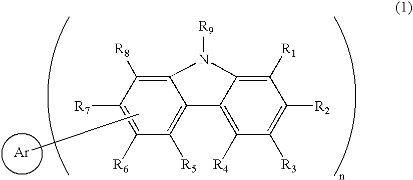
wherein Ar represents a substituted or unsubstituted bipyridine group, a substituted or unsubstituted terpyridine group, or a substituted or unsubstituted 4,5-diazafluorene group and is bonded to any of the eight available carbon atoms on the carbazole skeleton;
R₁, R₂, R₃, R₄, R₅, R₆, R₇, and R₈, when bonded to the available carbon atoms other than the Ar-bonded carbon atom(s) on the carbazole skeleton, and R₉ each represent, independently of one another, a hydrogen atom, a substituted or unsubstituted alkyl group, an aralkyl group, an alkoxy group, a substituted or unsubstituted aryl group, a substituted or unsubstituted heterocyclic group, a substituted amino group, a cyano group, or a halogen group, or adjacent ones of R₁, R₂, R₃, R₄, R₅, R₆, R₇, R₈, and R₉ may be joined to form a ring; and
n represents an integer of 1 to 4.

2. The carbazole compound according to claim 1, wherein Ar is a substituted or unsubstituted 4,5-diazafluorene group.

3. An organic light-emitting device comprising a pair of electrodes including an anode and a cathode, and an organic compound layer interposed between the pair of electrodes, wherein the organic compound layer comprises the compound set forth in claim 1.

4. The organic light-emitting device according to claim 3, wherein the organic compound layer is a light-emitting layer.
